(19) United States
(12) Patent Application Publication
(10) Pub. No.: US 2021/0366210 A1
(43) Pub. Date: Nov. 25, 2021

(54) ABNORMAL NOISE SOURCE IDENTIFICATION METHOD, ABNORMAL NOISE SOURCE IDENTIFICATION SYSTEM, ABNORMAL NOISE SOURCE IDENTIFICATION DEVICE, ABNORMAL NOISE SOURCE NOTIFICATION DEVICE, AND ON-BOARD DEVICE

(71) Applicant: TOYOTA JIDOSHA KABUSHIKI KAISHA, Toyota-shi (JP)

(72) Inventors: Koichi OKUDA, Toyota-shi (JP); Atsushi TABATA, Okazaki-shi (JP); Kota FUJII, Nissin-shi (JP); Ken IMAMURA, Toyota-shi (JP)

(73) Assignee: TOYOTA JIDOSHA KABUSHIKI KAISHA, Toyota-shi (JP)

(21) Appl. No.: 17/321,754

(22) Filed: May 17, 2021

(30) Foreign Application Priority Data
May 20, 2020 (JP) 2020-087963

(51) Int. Cl. G07C 5/08; G07C 5/00; G06F 16/635; G06F 16/638

(52) U.S. Cl. CPC G07C 5/0833; G07C 5/085; G06F 16/638; G07C 5/008; G06F 16/635; G07C 5/006

(57) ABSTRACT

Mapping data and data on individual difference variables are stored in a storage device. The mapping data are data that define a mapping including the individual difference variables and a sound variable in an input variable and including determination result variables in an output variable. The sound variable is a variable regarding noise generated by a vehicle, and the determination result variables are variables indicating a determination result of which of possible parts is the cause of the noise. A value of the input variable is acquired, the acquired value of the input variable is an input to the mapping to calculate a value of the output variable, and a notification device is operated to notify of a calculation result.

### CROSS-REFERENCE TO RELATED APPLICATION

This application claims priority to Japanese Patent Application No. 2020-087963 filed on May 20, 2020, incorporated herein by reference in its entirety.

### BACKGROUND

### 1. Technical Field

The disclosure relates to abnormal noise source identification methods, abnormal noise source identification systems, abnormal noise source identification devices, abnormal noise source notification devices, and on-board devices.

### 2. Description of Related Art

For example, Japanese Unexamined Patent Application Publication No. 2016-222090 (JP 2016-222090 A) describes a device that reduces abnormal noise due to backlash in a gear train in a hybrid vehicle in which motor generators and an internal combustion engine are mechanically coupled to a power split device having gear trains. When a predetermined abnormal noise generation condition is satisfied, this device controls the torque of the motor generator so as to apply pressing torque to the gear train.

### SUMMARY

Abnormal noise is not always generated in expected situations. It is therefore not always easy to identify the cause of abnormal noise when a user perceives the abnormal noise and tells that a vehicle makes an abnormal noise.

An abnormal noise source identification method according to a first aspect of the disclosure, includes, under a condition that mapping data and data on individual difference variables are stored in a storage device, the mapping data that defines a mapping including an input variable and an output variable, the input variable including the sound variable being a variable regarding the noise generated by a vehicle and the individual difference variables being variables regarding sounds unique to individuals of a plurality of possible parts, the possible parts being parts mounted on the vehicle and being possibly a cause of noise, the output variable including the determination result variables being variables indicating a determination result of which of the possible parts is the cause of the noise, causing an execution device to execute an acquisition process for acquiring a value of the input variable, a calculation process for inputting the value of the input variable acquired by the acquisition process to the mapping to calculate a value of the output variable, and a notification process for operating a notification device to notify of a calculation result of the calculation process.

Mass-produced parts have individual differences. The sound that is generated by each part shipped as a normal product therefore varies among individuals. Accordingly, when a vehicle mounted with a plurality of parts makes an abnormal noise, the individual differences of each part can be a clue to identify which of the parts is the cause of abnormal noise. According to the abnormal noise source identification method of the first aspect, the values of the determination result variables are calculated based on the values of the individual difference variables. Calculation accuracy of the values of the determination result variables can be increased as compared to the case where the values of the individual difference variables are not used.

In the abnormal noise source identification method of the first aspect, the individual difference variables for predetermined possible parts among the possible parts included in the input variable may be variables indicating positions of the predetermined possible parts in a distribution of the sounds unique to the individuals mounted on a plurality of the vehicles.

When the sounds of the predetermined possible parts deviate to a large extent from an average value of the sounds of the possible parts mounted on the vehicles, the predetermined possible parts are more likely to make an abnormal noise that is perceived than the possible parts located at the average value. However, for example, the relationship between the deviation of a sound pressure level or frequency from the average value and the position in the distribution tends to be nonlinear. According to the abnormal noise source identification method of the first aspect, since the variable indicating the position in the distribution is used, the output variable reflecting information on whether the position of the sound pressure level or frequency in the distribution deviates to a large extent from the average value can be calculated even without training the mapping on whether the position of the sound pressure level or frequency in the distribution deviates to a large extent from the average value.

In the abnormal noise source identification method of the first aspect, the storage device may be configured to store data on the individual difference variables of a plurality of vehicles and may not be included in the vehicle. The acquisition process may include a searching process of searching the data on the individual difference variables of the vehicles stored in the storage device for the individual difference variables of the vehicle for which the value of the output variable is to be calculated.

A request to identify the source of abnormal noise may not necessarily be made during the expected service life of the vehicle. Accordingly, storing the values of the individual difference variables of the individual vehicles may unnecessarily consume memory. According to the abnormal noise source identification method with the above configuration, the storage device configured to store the values of the individual difference variables is not included in the vehicle. This configuration reduces memory consumption.

In the abnormal noise source identification method of the first aspect, the sound variable included in the input variable may include a variable regarding magnitude of a sound pressure in a predetermined frequency band. According to the abnormal noise source identification method with the above configuration, the sound is quantified by the magnitude of the sound pressure in the predetermined frequency band. This configuration reduces an increase in number of dimensions of the input variable while capturing features of the sound.

In the abnormal noise source identification method with the above configuration, the predetermined frequency band may be a frequency band in which the sound pressure is higher than in low and high adjacent frequency bands. The sound variable included in the input variable may include a prominent frequency and a prominent amount. The prominent frequency is a frequency in the predetermined frequency band, and the prominent amount is an amount by which the sound pressure of the prominent frequency is prominent with respect to the adjacent frequency bands.

The sound having the prominent frequency tends to be an abnormal noise that is perceived by a user. According to the abnormal noise source identification method with the above configuration, since the sound variable includes the prominent frequency and the prominent amount, appropriate information for identifying the abnormal noise can be input to the mapping even though the number of dimensions of the input variable for the mapping is small. Accordingly, the source of abnormal noise can be accurately identified even though the number of dimensions of the input variable for the mapping is small.

In the abnormal noise source identification method of the first aspect, the input variable may include a traveled distance variable that is a variable having a correlation with a total traveled distance of the vehicle. The sounds of the parts of the vehicle tend to change with years of use, and the years of use of the parts have a strong positive correlation with the traveled distance. According to the abnormal noise source identification method with the above configuration, the traveled distance variable is added to the input variable. The amount of information on the sounds is thus increased. The value of the output variable can therefore be more accurately calculated as compared to the case where the traveled distance is not added to the input variable.

In the abnormal noise source identification method of the first aspect, the possible parts may include a part including a rotating element. The input variable may include a speed variable that is a variable indicating a rotational speed of the rotating element.

An abnormal noise from the possible part including the rotating element sometimes become remarkable when the rotational speed of the rotating element becomes a predetermined rotational speed. The rotational speed of the rotating element can therefore be information that is useful for identifying the abnormal noise. According to the abnormal noise source identification method with the above configuration, since the speed variable is included in the input variable, the value of the output variable can be more accurately calculated as compared to the case where the speed variable is not included in the input variable.

In the abnormal noise source identification method of the first aspect, the vehicle may include a stepped transmission configured to have a variable gear ratio between a rotational speed of an on-board rotating machine and a rotational speed of a drive wheel. The possible parts may include gears of the stepped transmission. The input variable may include a torque variable that is a variable indicating magnitude of torque applied to the gears.

An abnormal noise that is caused by the gears of the stepped transmission tends to be remarkable when the torque applied to the gears is large. The torque applied to the gears can therefore be information that is useful for identifying the abnormal noise. According to the abnormal noise source identification method with the above configuration, since the torque variable is included in the input variable, the value of the output variable can be more accurately calculated as compared to the case where the torque variable is not included in the input variable.

In the abnormal noise source identification method of the first aspect, the vehicle may include the stepped transmission configured to have the variable gear ratio between the rotational speed of the on-board rotating machine and the rotational speed of the drive wheel. The possible parts may include the gears of the stepped transmission. The input variable may include a gear ratio variable that is a variable indicating a gear ratio of the stepped transmission.

Since a power transmission path in the stepped transmission varies depending on the gear ratio, the possible part that causes an abnormal noise in the stepped transmission may also vary depending on the gear ratio. The gear ratio can therefore be information that is useful for identifying the abnormal noise. According to the abnormal noise source identification method with the above configuration, since the gear ratio variable is included in the input variable, the value of the output variable can be more accurately calculated as compared to the case where the gear ratio variable is not included in the input variable.

In the abnormal noise source identification method of the first aspect, the output variable may include a variable indicating that the noise is a sound generated when the parts mounted on the vehicle are normal.

Even when a sound generated by the possible part is within an expected range, a user with keen hearing may perceive this sound as abnormal noise. According to the abnormal noise source identification method with the above configuration, since the variable indicating that the noise is a sound that is generated in the normal state is included in the output variable, it becomes easier to fulfill accountability to users.

In the abnormal noise source identification method of the first aspect, the storage device may be configured to store sample data of abnormal noises of the possible parts, and the notification process may include a process of replaying the sample data of a possible part corresponding to the calculation result.

According to the abnormal noise source identification method with the above configuration, since the replayed sound of the sample data can be compared with the actually perceived abnormal noise, it becomes easier for a person to determine whether the calculation result of the value of the output variable is reasonable.

An abnormal noise source identification system according to a second aspect of the disclosure, includes the execution device, the storage device, the notification device, and the vehicle in the abnormal noise source identification method of the first aspect.

The execution device in the abnormal noise source identification system according to the second aspect, may include one or more of execution devices. An abnormal noise source identification device according to a third aspect of the disclosure, includes an execution device that is included in the one or more of the execution devices, and that is configured to execute the calculation process.

The execution device in the abnormal noise source identification system according to the second aspect, may include one or more of execution devices. An abnormal noise source notification device according to a fourth aspect of the disclosure, includes an execution device that is included in the one or more of the execution devices, and that is configured to execute the notification process, and the notification device.

An on-board device according to a fifth aspect of the disclosure, is configured to execute a transmission process of sending the input variable from the vehicle to the execution device in the abnormal noise source identification system according to the second aspect. In the fifth aspect, the execution device is not included in the vehicle. The vehicle includes a stepped transmission configured to have a variable gear ratio between a rotational speed of an on-board rotating machine and a rotational speed of a drive wheel. The input variable includes at least one of four variables: a speed variable that is a variable indicating a rotational speed of a rotating element of the stepped transmission, a torque variable that is a variable indicating magnitude of torque applied to the rotating element, a gear ratio variable that is a variable indicating the gear ratio of the stepped transmission, and a traveled distance variable that is a variable having a correlation with a total traveled distance of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of an abnormal noise source identification system according to a first embodiment of the disclosure;

FIG. 2 is a block diagram illustrating processes that are executed by a control device according to the first embodiment;

FIG. 3A is a flowchart of a process that is executed by the system;

FIG. 3B is a flowchart of a process that is executed by the system;

FIG. 4A is a graph illustrating an individual difference variable according to the first embodiment;

FIG. 4B is a graph illustrating an individual difference variable according to the first embodiment;

FIG. 4C is a graph illustrating an individual difference variable according to the first embodiment;

FIG. 5 is a graph illustrating a prominent frequency and a prominent amount according to the first embodiment;

FIG. 6 shows the content of abnormal noise source identification data according to the first embodiment;

FIG. 7 shows an example of display of the identification result of the source of abnormal noise according to the first embodiment;

FIG. 8 is a graph illustrating the relationship between the traveled distance and the sound pressure level according to the first embodiment;

FIG. 9 shows the configuration of an abnormal noise source identification system according to a second embodiment of the disclosure;

FIG. 10A is a flowchart of a process that is executed by a control device according to the second embodiment;

FIG. 10B is a flowchart of a process that is executed by a data center according to the second embodiment;

FIG. 11A is a flowchart of a process that is executed by a mobile terminal according to the second embodiment; and

FIG. 11B is a flowchart of a process that is executed by a maker device according to the second embodiment.

### DETAILED DESCRIPTION OF EMBODIMENTS

A first embodiment of an abnormal noise source identification method will be described with reference to the drawings.

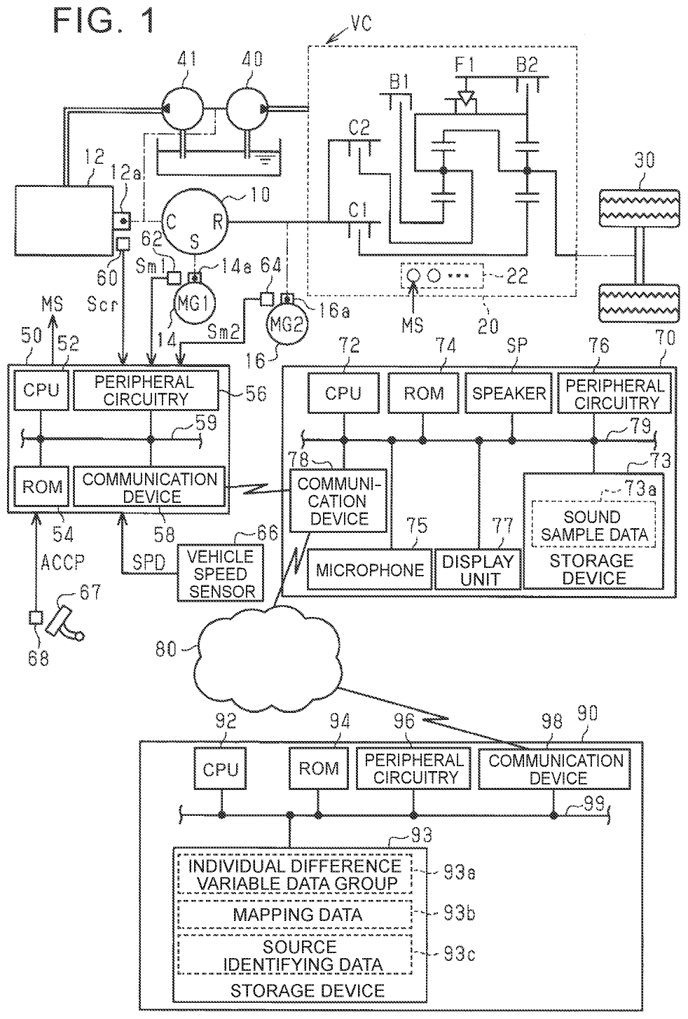

A vehicle VC shown in FIG. 1 is a series-parallel hybrid vehicle. That is, a power split device 10 of the vehicle VC includes a planetary gear mechanism including a sun gear S, a carrier C, and a ring gear R. A crankshaft 12a of an internal combustion engine 12 is mechanically coupled to the carrier C of the power split device 10. A rotating shaft 14a of a first motor generator 14 is mechanically coupled to the sun gear S. A rotating shaft 16a of a second motor generator 16 is mechanically coupled to the ring gear R. Drive wheels 30 are also mechanically coupled to the ring gear R via a transmission 20 including clutches C1, C2, brakes B1, B2, and a one-way clutch F1.

A driven shaft of an oil pump 40 is mechanically coupled to the carrier C of the power split device 10, and a driven shaft of an oil pump 41 is also mechanically coupled to the carrier C of the power split device 10. The transmission 20 is supplied with hydraulic oil discharged by the oil pump 40, and the internal combustion engine 12 is supplied with lubricating oil discharged by the oil pump 41.

A control device 50, which controls a vehicle, controls controlled variables such as torque and ratio of exhaust components of the internal combustion engine 12, torque of the first motor generator 14, and torque of the second motor generator 16. The control device 50 refers to an output signal Scr of a crank angle sensor 60, an output signal Sm1 of a first rotation angle sensor 62, and an output signal Sm2 of a second rotation angle sensor 64 in order to control the controlled variables. The first rotation angle sensor 62 detects the rotation angle of the rotating shaft 14a of the first motor generator 14. The second rotation angle sensor 64 detects the rotation angle of the rotating shaft 16a of the second motor generator 16. The control device 50 also refers to a vehicle speed SPD detected by a vehicle speed sensor 66 and an accelerator operation amount ACCP detected by an accelerator sensor 68. The accelerator operation amount ACCP is the amount of depression of an accelerator pedal 67.

The control device 50 includes a central processing unit (CPU) 52, a read only memory (ROM) 54, peripheral circuitry 56, and a communication device 58. These components of the control device 50 can communicate with each other via a local network 59. The peripheral circuitry 56 includes a circuit that generates clock signals defining an internal operation, a power supply circuit, a reset circuit, etc. The control device 50 controls the controlled variables by the CPU 52 executing programs stored in the ROM 54.

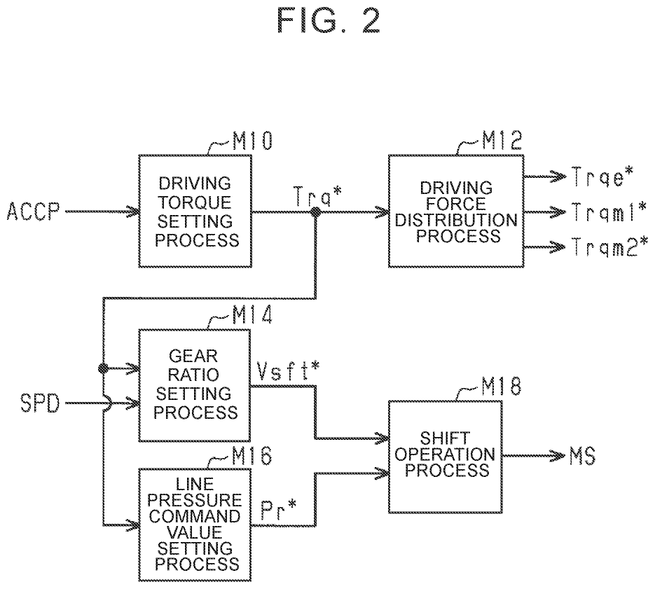

FIG. 2 shows a part of processes that are executed by the control device 50. The processes shown in FIG. 2 are implemented by the CPU 52 repeatedly executing the programs stored in the ROM 54 in, e.g., a predetermined cycle.

A driving torque setting process M10 is a process of receiving the accelerator operation amount ACCP as an input and calculating a driving torque command value Trq*. The driving torque command value Trq* is a command value for the torque to be applied to the drive wheels 30. In the driving torque setting process M10, the driving torque command value Trq* is set to a larger value when the accelerator operation amount ACCP is large than when the accelerator operation amount ACCP is small.

A driving force distribution process M12 is a process of setting a torque command value Trqe* for the internal combustion engine 12, a torque command value Trqm1* for the first motor generator 14, and a torque command value Trqm2* for the second motor generator 16, based on the driving torque command value Trq*. These torque command values Trqe*, Trqm1*, and Trqm2* are set to such values that the overall torque that is generated by the internal combustion engine 12, the first motor generator 14, and the second motor generator 16 and applied to the drive wheels 30 is equal to the driving torque command value Trq*.

A gear ratio setting process M14 is a process of setting a gear ratio command value Vsft* based on the vehicle speed SPD and the driving torque command value Trq*. The gear ratio command value Vsft* is a command value for the gear ratio of the transmission 20. A line pressure command value setting process M16 is a process of setting a line pressure command value Pr* based on the driving torque command value Trq*. The line pressure command value Pr* is a command value for the pressure of oil in the transmission 20. More specifically, in the line pressure command value setting process M16, the line pressure command value Pr* is set to a larger value when the driving torque command value Trq* is large than when the driving torque command value Trq* is small.

A shift operation process M18 is a process of outputting an operation signal MS to solenoid valves 22 of the transmission 20 based on the line pressure command value Pr* in order to control the pressure of the oil for hydraulically driving friction engagement elements such as the clutches and the brakes in the transmission 20 to the line pressure command value Pr* and to control the gear ratio to the gear ratio command value Vsft*.

Returning back to FIG. 1, the control device 50 can communicate with a dealership device 70 in a dealership and repair shop via the communication device 58. The dealership device 70 includes a CPU 72, a storage device 73, a ROM 74, a microphone 75, peripheral circuitry 76, a display unit 77 such as, e.g., a liquid crystal display (LCD), a communication device 78, and a speaker SP. These components of the dealership device 70 can communicate with each other via a local network 79. The storage device 73 is an electrically rewritable nonvolatile memory. The dealership device 70 may actually be, e.g., a combination of a portable scanning tool and a desktop terminal etc. owned by the dealership and repair shop.

The dealership device 70 can not only communicate with the control device 50 via the communication device 78 but also communicate with a maker device 90 owned by a vehicle maker of the vehicle VC via a global network 80.

The maker device 90 includes a CPU 92, a storage device 93, a ROM 94, peripheral circuitry 96, and a communication device 98. These components of the maker device 90 can communicate with each other via a local network 99. The storage device 93 is an electrically rewritable nonvolatile memory.

When the vehicle VC with a problem is brought to the dealership and repair shop, the maker device 90 together with the dealership device 70 executes a process such as identifying an abnormal portion. Especially, the maker device 90 executes a process of identifying the source of abnormal noise when the user says that the vehicle VC makes an abnormal noise. This will be described in detail.

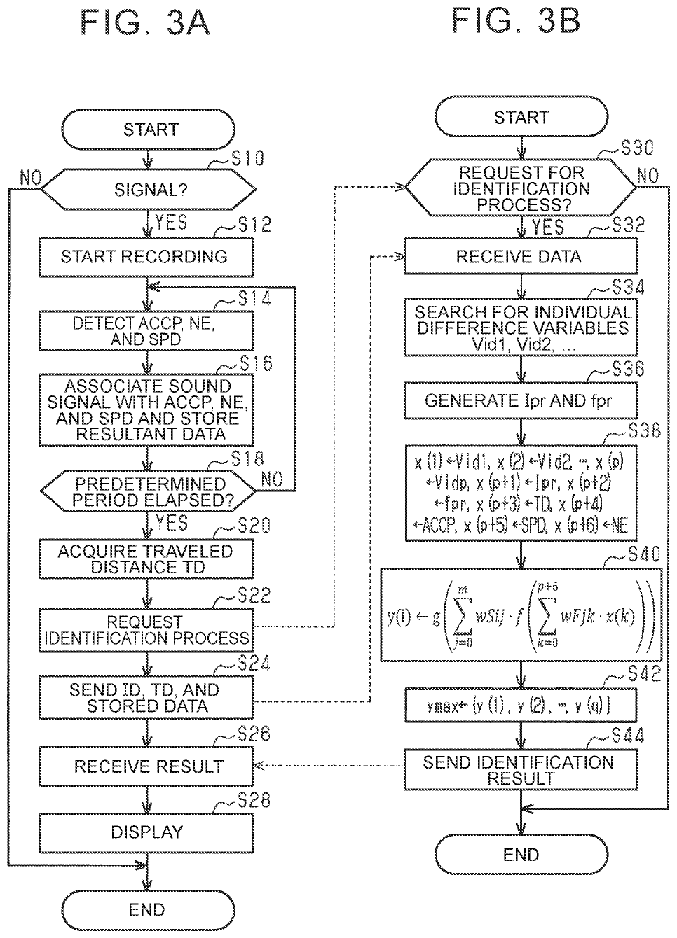

FIGS. 3A and 3B show processes regarding identifying the source of abnormal noise. The process shown in FIG. 3A is implemented by the CPU 72 repeatedly executing programs stored in the ROM 74 in, e.g., a predetermined cycle. The process shown in FIG. 3B is implemented by the CPU 92 repeatedly executing programs stored in the ROM 94 in, e.g., a predetermined cycle. In the following description, the step numbers of each process are indicated by numerals with the letter “S” at the beginning. The processes shown in FIGS. 3A and 3B will be described in chronological order of how the source of abnormal noise is identified.

When the vehicle VC is brought to the dealership and repair shop due to abnormal noise, a series of steps shown in FIG. 3A is performed for diagnosis while the vehicle VC is moving. In the series of steps shown in FIG. 3A, the CPU 72 first monitors for a signal indicating that a person has perceived an abnormal noise (S10). For example, a signal such as “now,” “start,” or “noise” is determined in advance, and the CPU 72 monitors for this signal based on an output signal of the microphone 75. When the CPU 72 determines that there is the signal (S10: YES), the CPU 72 starts recording a sound signal detected by the microphone 75 (S12). The CPU 72 then acquires the accelerator operation amount ACCP, the rotational speed NE of the crankshaft 12a, and the vehicle speed SPD from the control device 50 (S14). The rotational speed NE is calculated by the CPU 52 based on the output signal Scr. The CPU 72 then associates the sound signal output from the microphone 75 with the accelerator operation amount ACCP, the rotational speed NE, and the vehicle speed SPD that are acquired each time in step S14, and stores the resultant data in the storage device 73 (S16). The CPU 72 performs steps S14 and S16 until a predetermined period elapses from the start of recording in step S12 (S18: NO). When the CPU 72 determines that the predetermined period has elapsed (S18: YES), the CPU 72 acquires a traveled distance TD (S20). The CPU 72 then operates the communication device 78 to request the maker device 90 to execute a process of identifying the cause of the recorded sound signal (S22). Subsequently, the CPU 72 operates the communication device 78 to send an identification code ID of the vehicle VC, the traveled distance TD, and the data stored in step S16 to the maker device 90 (S24).

As shown in FIG. 3B, the CPU 92 of the maker device 90 of the vehicle maker determines whether there is a request for the process of identifying the cause of the recorded sound signal (S30). When the CPU 92 determines that there is a request (S30: YES), the CPU 92 receives the data sent in step S24 (S32). The CPU 72 then searches for and extracts individual difference variables Vid1, Vid2, . . . , Vidp of the vehicle corresponding to the received identification code ID from an individual difference variable data group 93a stored in the storage device 93 shown in FIG. 1 (S34). The individual difference variables Vid1, Vid2, . . . , Vidp are variables indicating the sounds the possible parts of the vehicle VC made when the vehicle VC are shipped. The possible parts are the parts of the vehicle VC that may be making the abnormal noise. The individual difference variables Vid1, Vid2, . . . , Vidp are assigned to the plurality of possible parts, one to each possible part. Examples of the possible parts include the oil pumps 40, 41, gears serving as power transmission parts when the transmission 20 is in first gear, and gears serving as power transmission parts when the transmission 20 is in second gear.

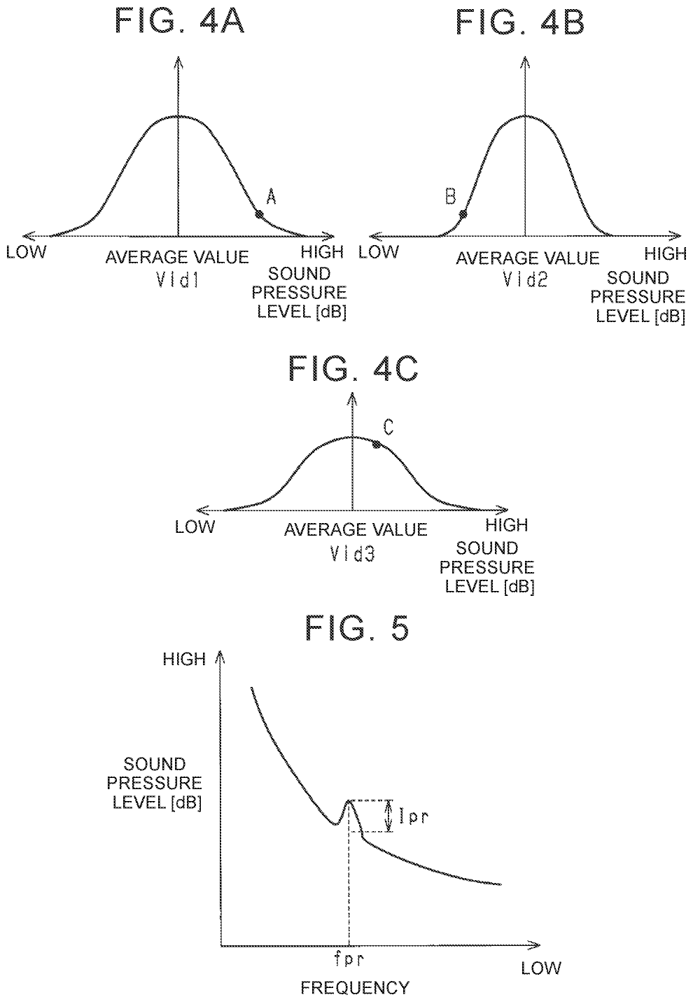

FIGS. 4A, 4B, and 4C illustrate the individual difference variables Vid1, Vid2, and Vid3. In FIGS. 4A, 4B, and 4C, the abscissa represents the sound pressure level of the possible part when the vehicle VC is shipped, and the ordinate represents, regarding one possible part, the proportion of the parts whose sound pressure level is the value on the abscissa out of the mass-produced parts. In the example of FIG. 4A, the individual difference variable Vid1 corresponds to the point A and indicates that the corresponding possible part is a part that makes a loud sound as compared with the average value of the sound pressure levels of the mass-produced parts. The individual difference variable Vid2 corresponds to the point B and indicates that the corresponding possible part is a part that makes a little sound as compared with the average value of the sound pressure levels of the mass-produced parts. The individual difference variable Vid3 corresponds to the point C and indicates that the corresponding possible part is a part that produces a sound of about the average value of the sound pressure level of the mass-produced parts.

In the embodiment, the individual difference variables Vid1, Vid2, Vid3, . . . , Vidp are not quantified by the loudness of the sound itself, but are quantified using a standard deviation σ. For example, the individual difference variables Vid1, Vid2, Vid3, . . . , Vidp are quantified by how many times the sound pressure level is as high as the standard deviation σ, such as “1.5σ.” A negative sign is added when the volume of the sound is lower than the average value.

Referring back to FIG. 3B, the CPU 92 generates a prominent frequency fpr and a prominent amount Ipr by a Fourier transform etc. of the received sound signal (S36). FIG. 5 illustrates the prominent frequency fpr and the prominent amount Ipr. As shown in FIG. 5, the prominent frequency fpr is a frequency in the frequency band in which the sound pressure level is prominent as compared to the low and high adjacent frequency bands. The prominent amount Ipr indicates the amount by which the sound pressure level is prominent as compared to the low and high adjacent frequency bands. In view of the fact that a sound having a prominent sound pressure level tends to be an abnormal noise, the prominent frequency fpr and the prominent amount Ipr are extracted in the embodiment. The CPU 92 defines the prominent frequency fpr and the prominent amount Ipr when the sound pressure levels in a subject frequency band are higher than the sound pressure levels in the low and high adjacent frequency bands by a predetermined amount or more. When the CPU 92 cannot define the prominent frequency fpr and the prominent amount Ipr, the CPU 92 gives a default value such as “0” to the prominent frequency fpr and the prominent amount Ipr in step S36.

Referring back to FIG. 3B, the CPU 92 assigns the values of the variables acquired in steps S34 and S36 in addition to the vehicle speed SPD, accelerator operation amount ACCP, rotational speed NE, and traveled distance TD acquired in step S32 to input variables x(1) to x(p+6) for a mapping that identifies the source of abnormal noise (S38). That is, the CPU 92 assigns the individual difference variable Vidi to the input variable x(i) (where i=1 to p), the prominent amount Ipr to the input variable x(p+1), and the prominent frequency fpr to the input variable x(p+2). The CPU 92 also assigns the traveled distance TD to the input variable x(p+3), the accelerator operation amount ACCP to the input variable x(p+4), the vehicle speed SPD to the input variable x(p+5), and the rotational speed NE to the input variable x(p+6).

The CPU 92 calculates the value of an output variable y(i) by assigning the input variables x(1) to x(p+6) generated in step S38 and an input variable x(0) that is a biasing parameter to the mapping defined by mapping data 93b stored in the storage device 93 shown in FIG. 1 (S40).

In the embodiment, the mapping is a function approximator, specifically a fully connected feedforward neural network with one intermediate layer. Specifically, the values of nodes of the intermediate layer are determined by transforming the input variables x(1) to x(p+6) to which the values have been assigned in step S38 and the bias parameter x(0) to “m” values by a linear mapping defined by a coefficient wFjk (j=1 to m, k=0 to “p+6”) and assigning each of the “m” values to an activation function f. The output variables y(1), y(2), y(3), . . . , y(q) are determined by transforming the values of the nodes of the intermediate layer by a linear mapping defined by a coefficient wSij and assigning each of the resultant values to an activation function g. In the embodiment, the activation function f is a hyperbolic tangent, and the activation function g is a softmax function.

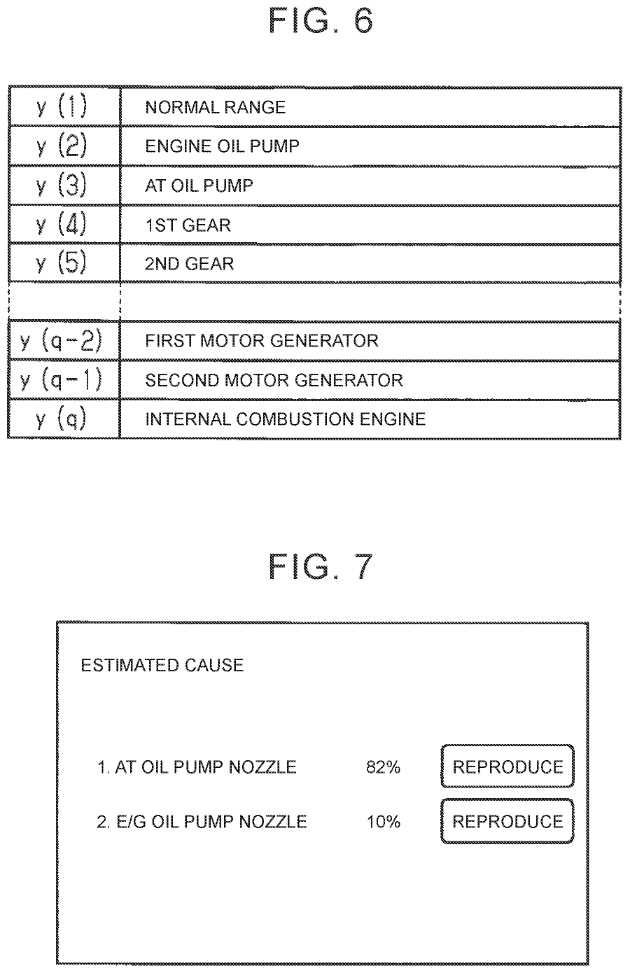

The output variables y(1), y(2), y(3), . . . , y(q) are variables each indicating the probability of the corresponding possible part actually being the source of abnormal noise. The output variables y(1), y(2), y(3), . . . , y(q) are defined by source identification data 93c stored in the storage device 93 shown in FIG. 1. FIG. 6 shows the source identification data 93c.

As shown in FIG. 6, the output variable y(1) indicates that the abnormal noise is in the normal range. For example, even if the sound pressure levels of the product whose sound pressure levels shown in FIGS. 4A, 4B, and 4C have an average value have not increased due to aging, a user with keen hearing may perceive a very little sound the product makes as abnormal noise. In this case, however, since this sound is acceptable in the design of the parts, it will be explained to the user that this sound is a sound the normal product makes.

In FIG. 6, the output variable y(2) indicates that the oil pump 41 that supplies lubricating oil to the internal combustion engine 12 is the source of abnormal noise, and the output variable y(3) indicates that the oil pump 40 that supplies hydraulic oil to the transmission 20 is the source of abnormal noise. The output variable y(4) indicates that 1st gear, which is the gears when the transmission 20 is in first gear, is the source of abnormal noise, and the output variable y(5) indicates that 2nd gear, which is the gears when the transmission 20 is in second gear, is the source of abnormal noise. The output variable y(q−2) indicates that the first motor generator 14 is the source of abnormal noise, the output variable y(q−1) indicates that the second motor generator 16 is the source of abnormal noise, and the output variable y(q) indicates that the internal combustion engine 12 is the source of abnormal noise.

Referring back to FIG. 3B, the CPU 92 calculates the values of the output variables y(1) to y(q) and assigns the largest one of the calculated output variables y(1) to y(q) to a maximum value ymax (S42). This is the step of identifying the source of abnormal noise. When the output variable y(1) is the maximum value ymax, the CPU 92 determines that the abnormal noise is in the normal range. When one of the output variables y(2) to y(q) is the maximum value ymax, the CPU 92 determines that the corresponding possible part is the source of abnormal noise.

The CPU 72 then operates the communication device 98 to send the identification result to the dealership device 70 (S44). When the CPU 92 completes step S44 or determines in step S30 that there is no request (S30: NO), the CPU 92 ends the series of steps shown in FIG. 3B.

The mapping data 93b is a learned model established using as training data various kinds of data produced regarding abnormal noise generated when prototype vehicles were driven under harsh conditions that accelerated degradation before the vehicle VC(1) was shipped. It is desirable that the training data for the output variable y(1) be “1” when the recorded sound is louder by a specified value or less than the average value determined by the individual difference variable data group 93a. That is, even when the sound has a sound pressure level initially expected to be acceptable, it is desirable to review the acceptable sound pressure level itself when many users perceive the sound as abnormal noise. It is therefore desirable to establish the learned model so that the sound is determined to be normal when its sound pressure level is equal to or lower than a predetermined level that is lower than an acceptable level for mass production.

As shown in FIG. 3A, the CPU 72 receives the identification result (S26). The CPU 72 then operates the display unit 77 to display visual information indicating the received identification result on the display unit 77 (S28).

FIG. 7 shows an example of display on the display unit 77. In the example of FIG. 7, the probability that the oil pump 40 that supplies hydraulic oil to the transmission 20 is the source of abnormal noise is “82%,” and the probability that the oil pump 41 that supplies lubricating oil to the internal combustion engine 12 is the source of abnormal noise is “10%.” This corresponds to the case where the output variable y(3) is the largest and the output variable y(2) is the second largest among the output variables y(1) to y(q).

In the embodiment, “reproduce” is also displayed. This is a tab indicating a command to replay the corresponding sound from sound sample data 73a stored in the storage device 73 shown in FIG. 1. The typical sound that is actually made by the part identified by the vehicle maker can thus be reproduced, and it can be checked whether the identification result is reasonable.

Referring back to FIG. 3A, when the CPU 72 completes step S28 or determines in step S10 that there is no signal (S10: NO), the CPU 72 ends the series of steps shown in FIG. 3A. Next, functions and effects of the embodiment will be described.

When the user brings the vehicle VC to the dealership and repair shop due to abnormal noise, the dealership and repair shop establishes communication with the control device 50 of the vehicle VC using the dealership device 70. The dealership device 70 then reproduces the abnormal noise and records the reproduced abnormal noise while the vehicle VC is traveling. The dealership device 70 sends the recorded sound signal etc. to the maker device 90 of the vehicle maker.

The maker device 90 extracts features of the sound from the received sound signal and, for the possible parts that may be making the abnormal noise out of the parts of the vehicle VC, searches for the individual difference variables Vid1, Vid2, . . . , Vidp each indicating the individual difference in sound unique to the corresponding part. The maker device 90 then inputs the extracted features of the sound and the values of the individual difference variables Vid1, Vid2, . . . , Vidp to the mapping defined by the mapping data 93b and calculates the output variables y(1) to y(q) each indicating the probability of the corresponding possible part being the source of abnormal noise. The CPU 92 identifies the source of abnormal noise based on the largest one of the output variables y(1) to y(q). As described above, the source of abnormal noise is identified using not only the features of the sound but also the values of the individual difference variables Vid1, Vid2, . . . , Vidp. Accordingly, more information that helps identify the source of abnormal noise is used than in the case where the source of abnormal noise is identified without using the values of the individual difference variables Vid1, Vid2, . . . , Vidp. The calculation accuracy of the values of the output variables y(1) to y(q) is thus improved.

The embodiment described above further has the following effects.

(1) The individual difference variables Vid1, Vid2, . . . , Vidp are quantified as variables indicating the position of the sound pressure level unique to the individual in the distribution of the sound pressure levels of the mass-produced parts, instead of quantifying the individual difference variables Vid1, Vid2, . . . , Vidp as the sound pressure levels unique to the individual. When the sound of a predetermined possible part is excessively louder than the average value of the sound pressure levels of the possible parts mounted on a plurality of vehicles, the predetermined possible part is more likely to make an abnormal noise that is perceived than the possible part located at the average value. However, for example, the relationship between the deviation of the sound pressure level from the average value and the position in the distribution tends to be nonlinear. The embodiment therefore uses the variable indicating the position in the distribution of the sound pressure level. Accordingly, the information on whether the position in the distribution deviates to a large extent from the average value can be added to the input variables. According to the embodiment, the output variables reflecting information on whether the position in the distribution deviates to a large extent from the average value can be calculated even without training the mapping on whether the position in the distribution deviates to a large extent from the average value.

(2) The individual difference variables Vid1, Vid2, . . . , Vidp of a plurality of vehicles are stored in the storage device 93 of the maker device 90. It is therefore not necessary to store the values of the individual difference variables Vid1, Vid2, . . . , Vidp in the individual vehicles VC. Storing the individual difference variables Vid1, Vid2, . . . , Vidp in the individual vehicles VC may unnecessarily consume memory because it is less probable that the vehicle VC will be brought to the dealership and repair shop due to abnormal noise.

(3) The prominent frequency fpr and the prominent amount Ipr are included in the input variables for the mapping. The prominent frequency fpr and the prominent amount Ipr are characteristic quantities that are seen when abnormal noise is generated. Accordingly, appropriate information for identifying the abnormal noise can be input to the mapping even though the number of dimensions of the input variables for the mapping is small.

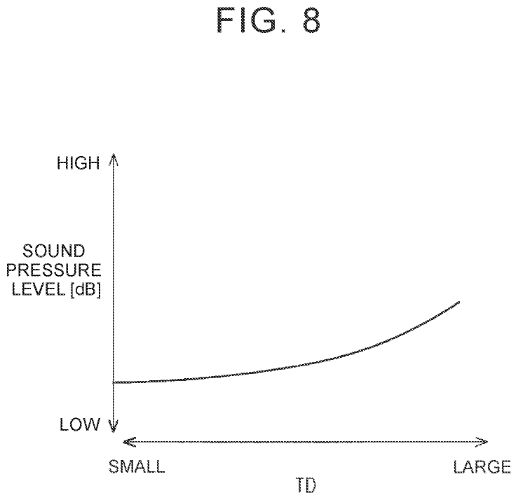

(4) The traveled distance TD is included in the input variables for the mapping. As shown in FIG. 8, sounds of the parts of the vehicle VC tend to change with the traveled distance TD. Accordingly, by adding the traveled distance TD to the input variables, the amount of information on the sounds is increased. The values of the output variables can therefore be more accurately calculated as compared to the case where the traveled distance TD is not added to the input variables.

(5) The vehicle speed SPD is included in the input variable for the mapping. The vehicle speed SPD is proportional to the rotational speed of rotating elements in the transmission 20. A sound generated by the transmission 20 sometimes becomes remarkable when the rotational speed of the rotating elements becomes a predetermined rotational speed. Accordingly, the vehicle speed SPD can be information that is useful for identifying the abnormal noise. In the embodiment, since the vehicle speed SPD is included in the input variables, the values of the output variables can be more accurately calculated as compared to the case where the vehicle speed SPD is not included in the input variables.

(6) The accelerator operation amount ACCP is included in the input variables for the mapping. An abnormal noise that is caused by the gears of the transmission 20 tends to be remarkable when the torque applied to the gears is large. Accordingly, the torque applied to the gears can be information that is useful for identifying the abnormal noise. The accelerator operation amount ACCP has a strong positive correlation with the torque applied to the gears. Accordingly, the accelerator operation amount ACCP can be information that is useful for identifying the abnormal noise. In the embodiment, since the accelerator operation amount ACCP is included in the input variables, the values of the output variables can be more accurately calculated as compared to the case where the accelerator operation amount ACCP is not included in the input variables.

(7) The accelerator operation amount ACCP and the vehicle speed SPD are included in the input variables for the mapping. Since the power transmission path in the transmission 20 varies depending on the gear ratio, the possible part that causes an abnormal noise in the transmission 20 may also vary depending on the gear ratio. Accordingly, the gear ratio can be information that is useful for identifying the abnormal noise. The gear ratio is determined by the vehicle speed SPD and the accelerator operation amount ACCP. In the embodiment, since the accelerator operation amount ACCP and the vehicle speed SPD are included in the input variables, the values of the output variables can be more accurately calculated as compared to the case where the accelerator operation amount ACCP and the vehicle speed SPD are not included in the input variables.

(8) The rotational speed NE is included in the input variables for the mapping. When the oil pumps 40, 41 make an abnormal noise, the oil pumps 40, 41 tend to have a predetermined rotational speed. The rotational speeds of the oil pumps 40, 41 are proportional to the rotational speed of the crankshaft 12a. Since the rotational speed NE is included in the input variables for the mapping, the values of the output variables can be calculated based on the information that is more closely related to the abnormal noise coming from the oil pumps 40, 41 and thus the values of the output variables can be more accurately calculated, as compared to the case where the rotational speed NE is not included in the input variables.

(9) The variable indicating that the noise is a sound generated when the parts mounted on the vehicle VC are normal is included in the output variables. Even when a sound generated by a possible part is within the expected range, a user with keen hearing may perceive this sound as abnormal noise. In the embodiment, since the variable indicating that the noise is a sound that is generated in the normal state is included in the output variables, it becomes easier to fulfill accountability to users.

(10) The sample data of abnormal noises of the possible parts that may be making an abnormal noise are stored in advance in the storage device 73, so that the sample data of the sound of the possible part identified as the source of abnormal noise can be replayed. Since the replayed sound of the sample data can be compared with the actually perceived abnormal noise, it becomes easier for a person to determine whether the calculation result of the values of the output variables is reasonable.

A second embodiment will be described with reference to the drawings, focusing on the differences from the first embodiment.

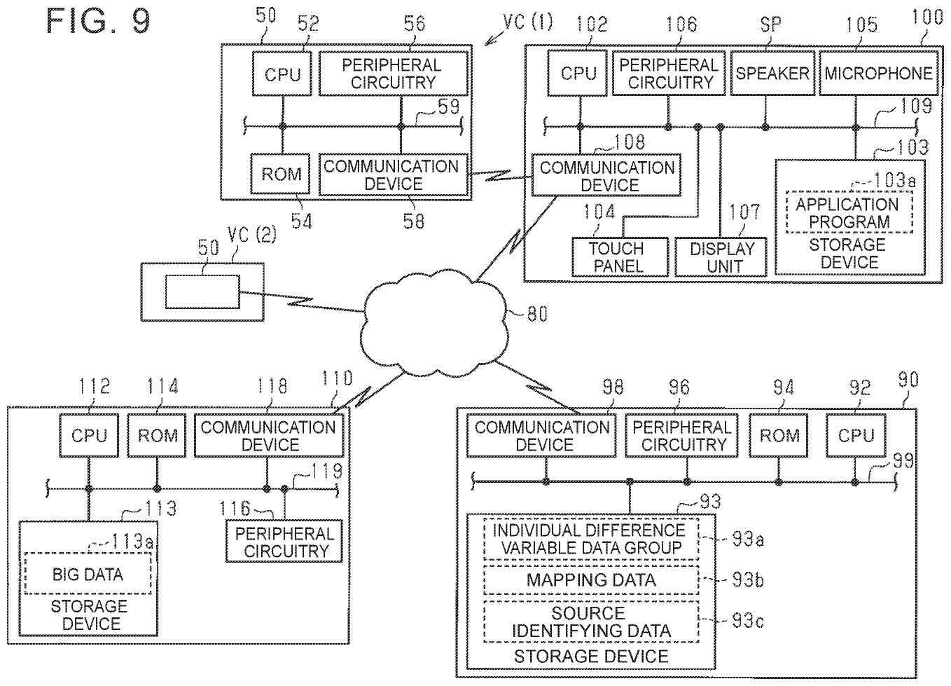

FIG. 9 shows the configuration of a system for identifying the source of abnormal noise according to the embodiment. Regarding the members shown in FIG. 9, the members corresponding to the members shown in FIG. 1 are denoted by the same signs and description thereof will be omitted for convenience.

A mobile terminal 100 shown in FIG. 9 is a terminal carried by a user of the vehicle VC. The mobile terminal 100 includes a CPU 102, an electrically rewritable nonvolatile storage device 103, a touch panel 104, a microphone 105, peripheral circuitry 106, a display unit 107 such as an LCD superimposed on the touch panel 104, a speaker SP, and a communication device 108. These components of the mobile terminal 100 can communicate with each other via a local network 109. The control device 50 for the vehicle VC can communicate with the mobile terminal 100 via the communication device 58.

A data center 110 includes a CPU 112, a storage device 113, a ROM 114, peripheral circuitry 116, and a communication device 118. These components of the data center 110 can communicate with each other via a local network 119. The storage device 113 is an electrically rewritable nonvolatile device. The storage device 113 has stored therein data sent from a plurality of vehicles VC(1), VC(2), . . . , VC(n) as big data 113a. The big data 113a includes data sent from a plurality of vehicles with different specifications. In the following description, it is assumed for convenience that the vehicles VC(1), VC(2), . . . , VC(n) are vehicles with the same specifications.

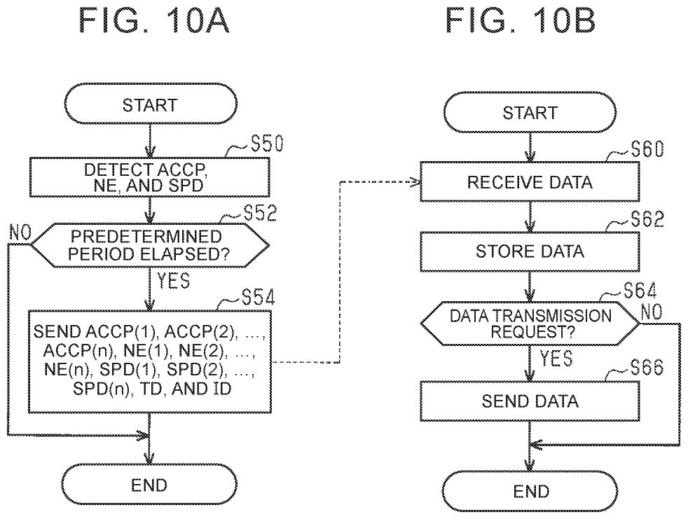

FIGS. 10A and 10B show processes regarding data communication of the data center 110. Specifically, the process shown in FIG. 10A is implemented by the CPU 52 repeatedly executing the programs stored in the ROM 54 in, e.g., a predetermined cycle.

The process shown in FIG. 10B is implemented by the CPU 112 repeatedly executing programs stored in the ROM 114 in, e.g., a predetermined cycle.

In the series of steps shown in FIG. 10A, the CPU 52 of the control device 50 first detects the accelerator operation amount ACCP, the rotational speed NE, and the vehicle speed SPD (S50). Next, the CPU 52 determines whether a predetermined period has elapsed from the execution timing of step S54 that will be described later (S52). When the CPU 52 determines that the predetermined period has elapsed (S52: YES), the CPU 52 operates the communication device 58 to send time-series data of the accelerator operation amount ACCP, the rotational speed NE, and the vehicle speed SPD, the traveled distance TD, and the identification code ID of the vehicle VC (S54). When the CPU 52 completes step S54 or determines in step S52 that the predetermined period has not elapsed (S52: NO), the CPU 52 ends the series of steps shown in FIG. 10A.

As shown in FIG. 10B, the CPU 112 of the data center 110 receives the data sent in step S54 (S60). Based on the identification code ID in the received data, the CPU 112 then updates vehicle data specified by the identification code ID out of the big data 113a stored in the storage device 113 with the time-series data and the traveled distance TD (S62). This updating step may be either the step of simply adding the received data or the step of deleting data older than a predetermined time and instead adding the received data.

The CPU 112 then determines whether there is a request for a specific part of the big data 113a. When the CPU 112 determines that there is a request (S64: YES), the CPU 112 operates the communication device 118 to send the requested data (S66).

When the CPU 112 completes step S66 or determines in step S64 that there is no request (S64: NO), the CPU 112 ends the series of steps shown in FIG. 10B.

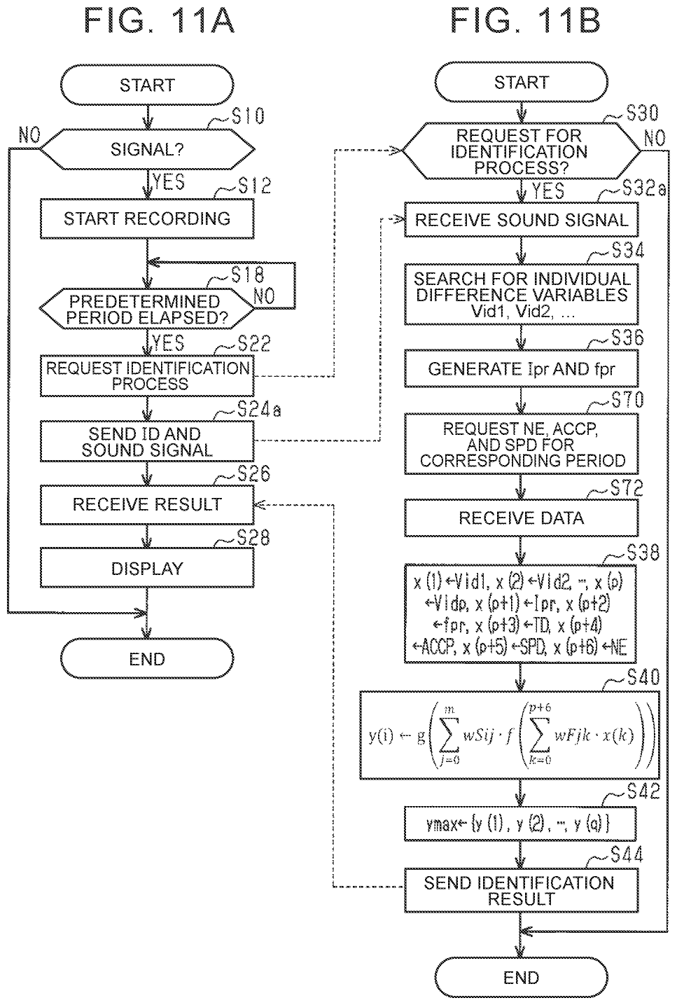

FIGS. 11A and 11B show processes of identifying the source of abnormal noise. Specifically, the process shown in FIG. 11A is implemented by the CPU 102 repeatedly executing an application program 103a stored in the storage device 103 shown in FIG. 9 every time a predetermined condition is satisfied. The process shown in FIG. 11B is implemented by the CPU 92 repeatedly executing the programs stored in the ROM 94 in, e.g., a predetermined cycle. In FIGS. 11A and 11B, the steps corresponding to the steps shown in FIGS. 3A and 3B are denoted by the same step numbers for convenience. The processes shown in FIGS. 11A and 11B will be described in chronological order of how the source of abnormal noise is identified.

In the series of steps shown in FIG. 11A, the CPU 102 of the mobile terminal 100 performs steps S10 and S12. When the CPU 102 determines that the recording has continued for a predetermined period (S18: YES), the CPU 102 performs step S22 and then operates the communication device 108 to send the identification code ID of the vehicle VC and the recorded sound signal (S24a).

As shown in FIG. 11B, when the CPU 92 determines in step S30 that there is a request for the process of identifying the cause of the recorded sound signal (S30: YES), the CPU 92 receives the data sent in step S24a (S32a). The CPU 92 then performs step S34 and also performs step S36 based on the data received in step S32a.

Subsequently, the CPU 92 operates the communication device 98 to request the data center 110 to send the rotational speed NE, accelerator operation amount ACCP, and vehicle speed SPD synchronized with the recording timing of the sound signal received in step S32a (S70). When the CPU 112 performs step S66 in the process shown in FIG. 10B in response to the request, the CPU 92 receives the data it requested (S72). The CPU 92 then performs steps S38 to S44 shown in FIG. 3B. Step S44 in the embodiment is the step of sending the identification result of the source of abnormal noise to the mobile terminal 100.

When the CPU 92 completes step S44 or determines in step S30 that there is no request (S30: NO), the CPU 92 ends the series of steps shown in FIG. 11B. In the series of steps shown in FIG. 11A, the CPU 102 of the mobile terminal 100 performs steps S26 and S28 that are performed by the dealership device 70 in the process of FIG. 3A. That is, when the CPU 102 receives the identification result, the CPU 102 operates the display unit 107 to display visual information indicating the received identification result on the display unit 77.

The correspondence between the matters described in the above embodiments and the matters described in the section “SUMMARY” is as follows. An example of the “storage device” is the storage device 93. An example of the “execution device” is the CPU 92 and the ROM 94. An example of the “sound variable” is the prominent amount Ipr and the prominent frequency fpr. An example of the “individual difference variables” is the individual difference variables Vid1, Vid2, . . . , Vidp. Examples of the “acquisition process” are steps S32, S34, and S36 in FIG. 3B and steps S32a, S34, and S36 in FIG. 11B. An example of the “calculation process” is step S40. When an example of the “notification device” is the display unit 77 or the display unit 107, an example of the “notification process” is step S28. When an example of the “notification device” is the communication device 98, an example of the “notification process” is step S44. An example of the “variable regarding the magnitude of the sound pressure in the predetermined frequency band” is the prominent amount Ipr. An example of the “traveled distance variable” is the traveled distance TD. An example of the “speed variable” is the rotational speed NE and the vehicle speed SPD. An example of the “transmission” is the stepped transmission 20. An example of the “torque variable” is the accelerator operation amount ACCP. An example of the “gear ratio variable” is the pair of vehicle speed SPD and accelerator operation amount ACCP. An example of the “output variables” is the output variables y(1), y(2), . . . , y(q). When an example of the “notification device” is the display unit 77, an example of the “abnormal noise source identification system” is the vehicle VC(1), the dealership device 70, and the maker device 90. When an example of the “notification device” is the display unit 107, an example of the “abnormal noise source identification system” is the vehicle VC(1), the mobile terminal 100, and the maker device 90. When an example of the “notification device” is the communication device 98, an example of the “abnormal noise source identification system” is the vehicle VC(1) and the maker device 90. When an example of the “notification device” is the display unit 77, an example of the “execution device” is the CPU 72 and the ROM 74. When an example of the “notification device” is the display unit 107, an example of the “execution device” is the CPU 102 and the storage device 103. When an example of the “notification device” is the communication device 98, an example of the “execution device” is the CPU 92 and the ROM 94. An example of the “on-board device” is the control device 50.

Other embodiments will be described below. The above embodiments can be modified as follows. The above embodiments and the following modifications can be combined unless technical inconsistency arises.

First, the sound signal will be described.

In the above embodiments, the sound signal corresponding to the abnormal noise is recorded while the vehicle VC is traveling. However, the disclosure is not limited to this. For example, the vehicle VC may be stopped at the dealership and repair shop, and the sound signal may be recorded with the internal combustion engine 12 etc. operated.

Next, the sound variable will be described.

The prominent frequency fpr and the prominent amount Ipr, which are input variables, are not limited to one pair. For example, there may be a plurality of pairs of prominent frequency fpr and prominent amount Ipr. In this case, for example, the maximum number of input variables expected as the number of pairs of prominent frequency fpr and prominent amount Ipr is prepared. When the actual number of pairs of prominent frequency fpr and prominent amount Ipr is smaller than the maximum number, “0” etc. may be assigned to the remaining input variables.

The sound variable is not limited to the variable composed of the pair of prominent frequency fpr and prominent amount Ipr. For example, the sound variable may be sound pressure levels at some predetermined frequencies. For example, the predetermined frequencies may be variable in proportion to the rotation frequency of the transmission 20.

The sound variable is not limited to the sound pressure level at a predetermined frequency. For example, the sound variable may be duration of the sound pressure level being equal to or higher than a threshold value.

The individual difference variables will be described.

The individual difference variables are not limited to the variables regarding the magnitude of the sound pressure level. For example, the individual difference variables may be variables regarding the frequency of the sound or may be variables regarding both the sound pressure level and its frequency.

The individual difference variables are not limited to the variables quantified by how many times the sound pressure level of the subject part in the distribution is as high as the standard deviation σ. For example, the individual difference variables may be quantified by what percentage of the parts in the population is included in the range of the absolute value of the difference between the sound pressure level of the subject part and the average value of the sound pressure levels of the population from this average value.

The individual difference variables are not limited to variables quantifying the position of the sound pressure level of the subject part in the distribution of the population. For example, the individual difference variables may be the sound pressure level unique to the subject part.

The storage device for the data on the individual difference variables will be described.

The storage means for storing the individual difference variables Vid1, Vid2, . . . , Vidp is not limited to the storage device 93 that collectively stores the individual difference variables of a plurality of vehicles as the individual difference variable data group 93a. For example, the storage device included in the control device 50 of each vehicle VC(1), VC(2), . . . , VC(n) may store only the individual difference variables of that vehicle.

The traveled distance variable will be described.

The traveled distance variable is not limited to the traveled distance TD, and may be simply the number of years of use.

The speed variable will be described.

The variable indicating the rotational speed of the rotating element in the transmission 20 is not limited to the vehicle speed SPD. For example, the variable indicating the rotational speed of the rotating element in the transmission 20 may be the rotational speed of an input shaft of the transmission 20. In the above embodiments, this is equal to the rotational speed of the rotating shaft 16a of the second motor generator 16. For example, the variable indicating the rotational speed of the rotating element in the transmission 20 may be an actual rotational speed of each rotating element calculated from the vehicle speed SPD and the gear ratio. In this case, the speed variable is a set of variables.

The variable indicating the rotational speeds of the oil pumps 40, 41 is not limited to the rotational speed NE. For example, in view of the fact that the rotational speed NE of the crankshaft 12a is uniquely determined by the combination of the rotational speed of the rotating shaft 14a of the first motor generator 14 and the rotational speed of the rotating shaft 16a of the second motor generator 16, the variable indicating the rotational speeds of the oil pumps 40, 41 may be this combination of the rotational speeds. For example, in view of the fact that the rotational speed NE is substantially determined by the combination of the vehicle speed SPD and the accelerator operation amount ACCP, the variable indicating the rotational speeds of the oil pumps 40, 41 may be the combination of the vehicle speed SPD and the accelerator operation amount ACCP. It is not essential that the variable indicating the rotational speeds of the oil pumps 40, 41 be included in the input variables.

The torque variable will be described.

The torque variable is not limited to the accelerator operation amount ACCP. For example, the torque variable may be the driving torque command value Trq* or may be the set of torque command values Trqe*, Trqm1*, and Trqm2*.

The gear ratio variable will be described.

In the above embodiments, the gear ratio variable is composed of the accelerator operation amount ACCP and the vehicle speed SPD. However, the disclosure is not limited to this. For example, the gear ratio command value Vsft* may be included as the gear ratio variable in the input variables.

The output variables for the mapping will be described.

It is not essential that the variable indicating that the abnormal noise is in the normal range be included in the output variables for the mapping.

It is also not essential that the possible parts determined by the output variables include all of the parts shown in FIG. 6.

The mapping will be described.

In the above embodiments, the hyperbolic tangent is illustrated as the activation function f, and the softmax function is illustrated as the activation function g. However, the disclosure is not limited to this. For example, the activation function f may be a rectified liner unit (ReLu).

In the above embodiments, the neural network with one intermediate layer is illustrated as the neural network. However, the disclosure is not limited to this. The number of intermediate layers may be two or more.

In the above embodiments, the fully connected feedforward neural network is illustrated as the neural network. However, the disclosure is not limited to this. For example, the neural network may be a convolutional neural network or a recurrent neural network.

The function approximator as a mapping is not limited to the neural network. For example, the function approximator may be a regression equation with no intermediate layer. For example, the function approximator may include for each of the possible parts an identification model indicating whether the possible part is the source of abnormal noise. In other words, instead of using one function approximator that identifies the source of abnormal noise, the same number of function approximators as the number of possible parts may be used.

The abnormal noise source identification system will be described.

In the above embodiments, the individual difference variable data group 93a is stored in the maker device 90. However, the disclosure is not limited to this. For example, in the system of FIG. 9, the individual difference variable data group 93a may be stored in the data center 110. In this case, for example, when the maker device 90 calculates the output variables y(1), y(2), . . . , y(q), the maker device 90 may request the data center 110 for the values of the corresponding variables in the individual difference variable data group 93a.

In the above embodiments, the output variables y(1), y(2), . . . , y(q) are calculated by the maker device 90. However, the disclosure is not limited to this. For example, the output variables y(1), y(2), . . . , y(q) may be calculated by the dealership device 70. In this case, for example, the dealership device 70 may request the maker device 90 for the values of the corresponding variables in the individual difference variable data group 93a. The entity that calculates the output variables y(1), y(2), . . . , y(q) is not limited to the dealership device 70, and may be, e.g., the data center 110 shown in FIG. 9.

The execution device will be described.

The execution device is not limited to the device that includes the CPU 92 (72, 102) and the ROM 94 (74, 104) and executes software processing. For example, the execution device may include a dedicated hardware circuit such as an application specific integrated circuit (ASIC) that executes at least a part of processing executed by software in the above embodiments by hardware. That is, the execution device may have any of the following configurations (a) to (c): (a) the execution device including a processing device that executes all of the above processing according to programs and a program storage device such as a ROM that stores the programs, (b) the execution device including a processing device and a program storage device that execute a part of the above processing according to programs and a dedicated hardware circuit that executes the remaining processing, and (c) the execution device including a dedicated hardware circuit that executes all of the above processing. There may be a plurality of software execution devices including a processing device and a program storage device or a plurality of dedicated hardware circuits.

The notification device will be described.

In the above embodiments, the device that notifies of the information on the values of the output variables for the mapping as visual information is illustrated as the notification device that notifies the information on the values of the output variables for the mapping which can be perceived by the user. However, the disclosure is not limited to this. For example, the notification device may be a device that notifies of the information on the values of the output variables for the mapping as voice information.

The vehicle will be described.

The vehicle is not limited to the vehicle including the transmission 20. The vehicle is not limited to the series-parallel hybrid vehicle. For example, the vehicle may be a series hybrid vehicle or a parallel hybrid vehicle. The on-board rotating machine is not limited to the on-board rotating machine including an internal combustion engine and a motor generator. For example, the vehicle may be a vehicle that has an internal combustion engine but does not have a motor generator, or may be a vehicle that has a motor generator but does not have an internal combustion engine.

What is claimed is:

1. An abnormal noise source identification method comprising
under a condition that mapping data and data on individual difference variables are stored in a storage device, the mapping data that defines a mapping including an input variable and an output variable, the input variable including a sound variable being a variable regarding noise generated by a vehicle and the individual difference variables being variables regarding sounds unique to individuals of a plurality of possible parts, the possible parts being parts mounted on the vehicle and being possibly a cause of noise, the output variable including determination result variables being variables indicating a determination result of which of the possible parts is the cause of the noise, causing an execution device to execute:
an acquisition process for acquiring a value of the input variable;
a calculation process for inputting the value of the input variable acquired by the acquisition process to the mapping to calculate a value of the output variable; and
a notification process for operating a notification device to notify of a calculation result of the calculation process.

2. The abnormal noise source identification method according to claim 1, wherein the individual difference variables for predetermined possible parts among the possible parts included in the input variable are variables indicating positions of the predetermined possible parts in a distribution of the sounds unique to the individuals mounted on a plurality of vehicles.

3. The abnormal noise source identification method according to claim 1, wherein:
the storage device is configured to store data on the individual difference variables of a plurality of vehicles and is not included in the vehicle; and
the acquisition process includes a searching process of searching the data on the individual difference variables of the vehicles stored in the storage device for the individual difference variables of the vehicle for which the value of the output variable is to be calculated.

4. The abnormal noise source identification method according to claim 1, wherein the sound variable included in the input variable includes a variable regarding magnitude of a sound pressure in a predetermined frequency band.

5. The abnormal noise source identification method according to claim 4, wherein:
the predetermined frequency band is a frequency band in which the sound pressure is higher than in low and high adjacent frequency bands; and
the sound variable included in the input variable includes a prominent frequency and a prominent amount, the prominent frequency being a frequency in the predetermined frequency band and the prominent amount being an amount by which the sound pressure of the prominent frequency is prominent with respect to the adjacent frequency bands.

6. The abnormal noise source identification method according to claim 1, wherein the input variable includes a traveled distance variable, the traveled distance variable being a variable having a correlation with a total traveled distance of the vehicle.

7. The abnormal noise source identification method according to claim 1, wherein:
the possible parts include a part including a rotating element; and
the input variable includes a speed variable, the speed variable being a variable indicating a rotational speed of the rotating element.

8. The abnormal noise source identification method according to claim 1, wherein:
the vehicle includes a stepped transmission configured to have a variable gear ratio between a rotational speed of an on-board rotating machine and a rotational speed of a drive wheel;
the possible parts include gears of the stepped transmission; and
the input variable includes a torque variable, the torque variable being a variable indicating magnitude of torque applied to the gears.

9. The abnormal noise source identification method according to claim 1, wherein:
the vehicle includes a stepped transmission configured to have a variable gear ratio between a rotational speed of an on-board rotating machine and a rotational speed of a drive wheel;
the possible parts include the gears of the stepped transmission; and
the input variable includes a gear ratio variable, the gear ratio variable being a variable indicating a gear ratio of the stepped transmission.

10. The abnormal noise source identification method according to claim 1, wherein the output variable includes a variable indicating that the noise is a sound generated when the parts mounted on the vehicle are normal.

11. The abnormal noise source identification method according to claim 1, wherein:
the storage device is configured to store sample data of abnormal noise of each of the possible parts; and
the notification process includes a process of replaying the sample data of the possible parts corresponding to the calculation result.

12. An abnormal noise source identification system comprising the execution device, the storage device, the notification device, and the vehicle in the abnormal noise source identification method according to claim 1.

13. An abnormal noise source identification device, wherein the execution device in the abnormal noise source identification system according to claim 12 includes one or more of execution devices,
the abnormal noise source identification device comprising:
an execution device that is included in the one or more execution devices, and that is configured to execute the calculation process.

14. An abnormal noise source notification device, wherein the execution device in the abnormal noise source identification system according to claim 12 includes one or more of execution devices,
the abnormal noise source notification device comprising:
an execution device that is included in the one or more execution devices, and that is configured to execute the notification process; and
the notification device.

15. An on-board device that is configured to execute a transmission process of sending the input variable from the vehicle to the execution device in the abnormal noise source identification system according to claim 12, wherein:
the execution device is not included in the vehicle;
the vehicle includes a stepped transmission configured to have a variable gear ratio between a rotational speed of an on-board rotating machine and a rotational speed of a drive wheel; and
the input variable includes at least one of four variables that are
a speed variable that is a variable indicating a rotational speed of a rotating element of the stepped transmission,
a torque variable that is a variable indicating magnitude of torque applied to the rotating element,
a gear ratio variable that is a variable indicating the gear ratio of the stepped transmission, and
a traveled distance variable that is a variable having a correlation with a total traveled distance of the vehicle.
